(19) United States
(12) Patent Application Publication
(10) Pub. No.: US 2002/0105652 A1
(43) Pub. Date: Aug. 8, 2002

(54) Tunable optical filter

(76) Inventors: Lawrence H. Domash, Conway, MA (US); Nikolay Nemchuk, North Andover, MA (US); Matthias Wagner, Boston, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/005,174

(22) Filed: Dec. 4, 2001

Related U.S. Application Data
(60) Provisional application No. 60/250,883, filed on Dec. 4, 2000.

(51) Int. Cl. G01B 9/02

(52) U.S. Cl. 356/481

(57) ABSTRACT

A method of controlling an optical signal having a first wavelength, includes passing the optical signal through a device, the device substantially transparent to the first wavelength; and selectively illuminating the device with an optical signal at a second wavelength, illumination of the device by the second wavelength causing alteration of optical properties of the device relative to the first wavelength. An optically controlled optical filter, includes a semiconductor film whose transmission of a first optical wavelength varies with illumination at a second optical wavelength.

### CROSS REFERENCE TO RELATED APPLICATION

This application claims domestic priority under 35 U.S.C. §119(e) to U.S. Provisional Patent Application serial No. 60/250,883, filed Dec. 4, 2000, incorporated herein by reference.

This application is related to U.S. patent applications Ser. Nos. 09/813,454, filed Mar. 20, 2001 and 09/813,362, filed Mar. 20, 2001, both incorporated herein by reference.

### BACKGROUND

1. Field

The present disclosure relates generally to optical filters. More particularly, the disclosure relates to tunable optical filters. Yet more particularly, the disclosure relates to tunable optical filters that are remotely actuated.

2. Related Art

One common practice for transmitting multiple channels of information through an optical network is to use wavelength division multiplexing (WDM) to separate the channels by carrier wavelength. In order to separate the channels in WDM systems, the wavelength response of one or more components of the network must be tunable. WDM systems are expected to operate in a band of wavelengths spanning the range of 1,200-1,600 nm. Hundreds, or even thousands of channels can be accommodated in such a system having channels spaced apart by wavelength differences of 0.2 nm.

Components that should be tunable for optimum performance include, but are not limited to add/drop filters, lasers, detectors, cross-connect switches and others. Of these, the add/drop filter is representative, and will be discussed further in detail.

Many methods of tuning optical components, such as add/drop filters are known, but each has limitations affecting one or more applications for the method. For example, conventional methods of tuning optical components includes in three-dimensional structures, the physical rotation of optical thin film interference filters and the physical rotation of optical diffraction gratings; and in two-dimensional structures, thermo-optic effects, stretching of fibers, use of liquid crystals, use of micro-electro-mechanical systems (MEMS) such as tunable Fabry-Perot cavities or vertical cavity surface emitting lasers (VCSELs), etc. One technique used in distributed feedback (DFB) lasers to effect tunability is charge injection into semiconductor single crystal waveguide segments, thereby altering the index of the segments. In general, methods which alter the refractive index of a structure also usually tune the structure with respect to wavelength.

It is well known that single-crystal, pure and compound semiconductors including GaAs, InP, etc. alter their index in response to carrier density, generally controlled by current and charge injection. This is sometimes studied under the topic of electro-absorption. Physically, it is known that changes in the spectral absorption, i.e., the imaginary part of the complex refractive index, of a semiconductor are necessarily also accompanied by changes in the index, i.e., the real part of the complex refractive index, as well. The two are related through the Kramers-Kronig equation.

Related fundamental physical effects are present, although possibly in smaller magnitude due to the degree of defect density, in amorphous or nanocrystalline semiconductor films such as may be used to create photodetectors or solar cells on transparent glass substrates. In a reverse biased photodetector, charge carriers are deposited by photons absorbed in the band of spectral sensitivity. Thus, it is expected that finite changes in refractive index of such films can be induced optically Electroabsorption in amorphous semiconductors have been studied by Eric Schiff and others. For example, see “Electroabsorption Measurements and Built-In Potentials in Amorphous Silicon Solar Cells,” Lin Jiang, Qi Wang, E. A. Schiff, S. Guha, J. Yang, and X. Deng, Appl. Phys. Lett. 69, 3063 (1996), and others.

The methods noted above are nearly all electrically actuated. This is disadvantageous in some applications because the system is more complex and requires both electrical and optical signal generation, transmission and detection. For example, in transoceanic applications there may be no local supply of electric power, thus necessitating a high reliability, high power signaling system.

### SUMMARY OF THE INVENTION

It is an object of the invention to provide a method and filter for controlling optical signals.

According to one aspect of an embodiment, there is a method of controlling an optical signal having a first wavelength, comprising: passing the optical signal through a device, the device substantially transparent to the first wavelength; and selectively illuminating the device with an optical signal at a second wavelength, illumination of the device by the second wavelength causing alteration of optical properties of the device relative to the first wavelength. The device may be a Mach-Zender modulator. The device may be a filter. The filter may further comprise a film having an index of refraction that varied in response to the second wavelength. The filter may yet further comprise a diffraction grating optically coupled to the side-polished fiber. In that case, the filter further comprises a side-polished fiber.

According to another aspect of an embodiment, an optically controlled optical filter comprises a semiconductor film whose transmission of a first optical wavelength varies with illumination at a second optical wavelength. The semiconductor film can have a refractive index at the first optical wavelength that varies with illumination as the second optical wavelength. The filter can alternatively include a diffraction grating incorporated into the semiconductor film; and a side-polished fiber coupled to the diffraction grating.

### BRIEF DESCRIPTION OF THE DRAWING

In the Figures, in which like reference designations indicate like elements:

FIG. 1 is a perspective view of a structure incorporating aspects of an embodiment of the invention;

FIG. 2 is a schematic representation of aspects of an embodiment of the invention incorporating a Mach-Zender waveguide interferometer;

FIG. 3 is a schematic representation of aspects of another embodiment of the invention incorporating a Mach-Zender waveguide interferometer;

FIG. 4 is a perspective view of aspects of an embodiment of the invention incorporating a side-polished fiber structure;

FIG. 5 is a graph of the transmission spectrum produced by the structure of FIG. 4;

FIG. 6 is a perspective view of a structure incorporating aspects of an embodiment of the invention employing an optically variable diffraction grating; and

FIG. 7 is a perspective view of another structure employing a diffraction grating with a side-polished fiber structure.

### DETAILED DESCRIPTION

The present invention will be better understood upon reading the following detailed description of various aspects of embodiments thereof in connection with the drawing.

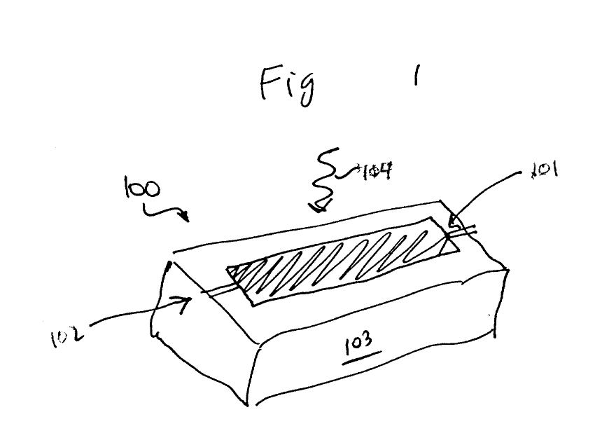

One aspect of an embodiment of the invention is now described in connection with FIG. 1. Photodetectors fabricated from films of amorphous silicon in a PIN structure, or alternatively an open-circuit photovoltaic cell, as shown in FIG. 1 can be optically controlled. Exemplary embodiments of aspects of the invention are described with reference to specific wavelengths, but should not be considered so limited. Other materials and variations operate at other wavelengths. According to this aspect, the index at a wavelength where these films are largely transparent, such as the communications wavelength 1550 nm is altered by means of illumination at a shorter wavelength where the films are absorptive, for example 850 nm. Using this effect, it is possible to alter the index and thereby the speed or phase of propagation of light at 1550 nm in the film, indirectly, by means of optical illumination at 850 nm. This is an optically controlled optical effect, meaning that the 850 nm light indirectly alters the behavior of the 1550 nm light, and as such can be the basis for a remotely tuned filter, remotely operated switch, or other device.

The fundamental structure 100 shown in FIG. 1 is a planar optical waveguide 101 fabricated from semiconductor films made in a multilayered structure designed to enhance and preserve the charge carrier density. Methods of such enhancement are described in related U.S. patent applications Ser. Nos. 09/813,362 and 09/813,454. The film layers perform two functions simultaneously. First, they act as a photovoltaic generator of charge carriers with respect to relatively shorter wavelengths, for example 850 nm, where the films are opaque and absorptive. Second, the films act as a waveguide for relatively longer wavelengths, for example 1550 nm, where silicon and other semiconductors are predominantly transparent. The index of a-Si films at 1550 nm is approximately n=3, depending on film properties. Thus, a guiding film for 1550 nm light 102 injected longitudinally will be formed by a thin layer if the top is clad by air and the substrate 103 is glass or fused silica. The central signal of 850 nm light 104 impinges on a top surface of the waveguide 101. For a PIN diode, the total thickness may be between 6.25 μm and 10 μm. This may be designed to be a multimode or single mode waveguide, depending on the exact index and thickness.

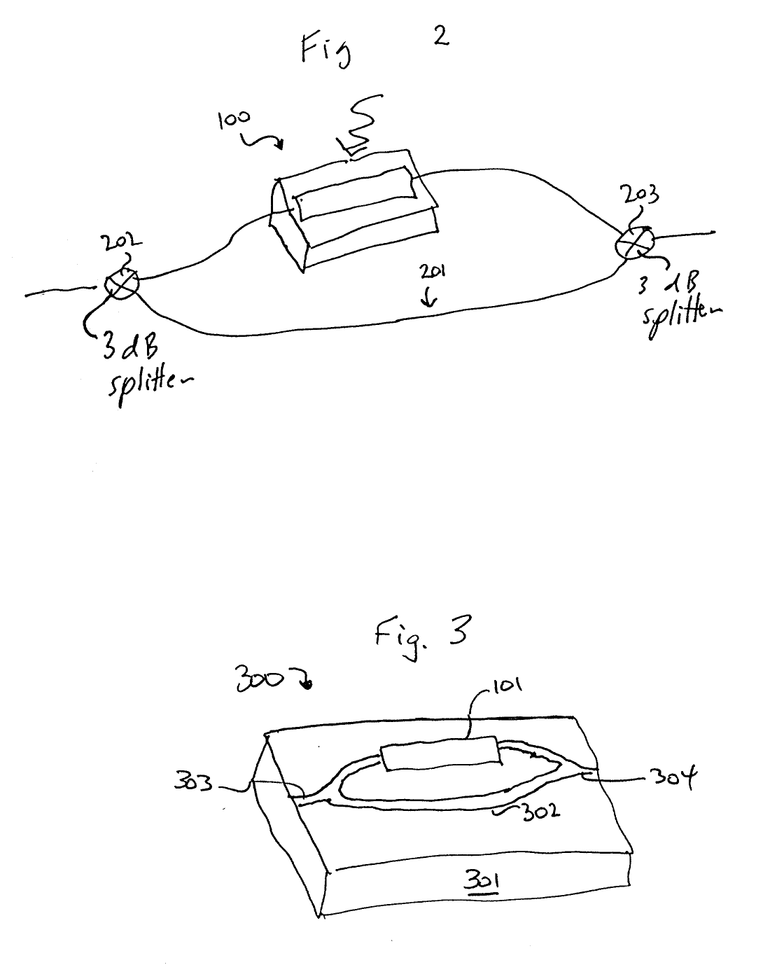

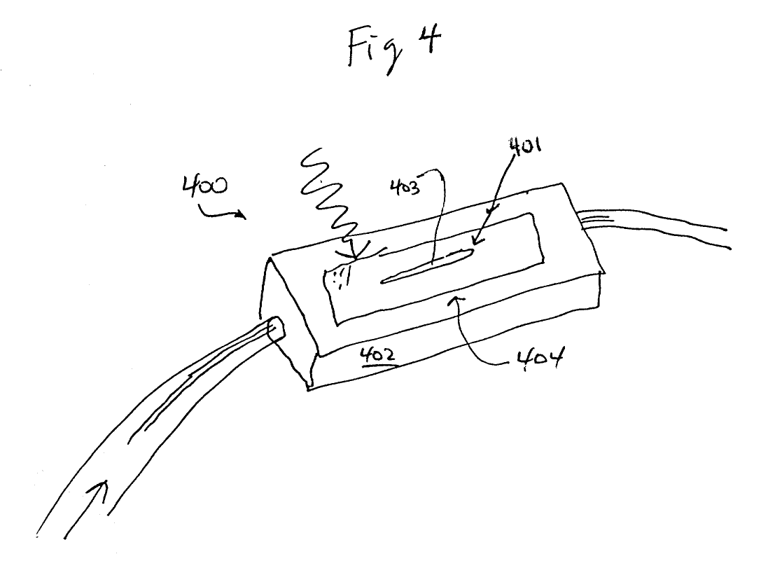

Several methods are proposed to produce a detectable alteration in 1550 propagation by means of illumination at 850 nm. FIGS. 2 and 3 show Mach-Zehnder arrangements whereby changes in the phase shift of the semiconductor waveguide are revealed, by means of interference with the parallel fiber or waveguide, by the changes in amplitude in the output fiber. Phase shifts of 0.1 waves are easily detectable by this method, corresponding to an index change of 3×10⁻⁴.

In FIG. 2, the structure 100 of FIG. 1 is placed in parallel with a strand of single-mode fiber 201. An input signal is admitted to the parallel structure throng (a 3 dB splitter 202 and the resultant signal is produced by a second 3 dB splitter 203 employed as a joiner).

Alternatively, as shown in FIG. 3, the entire structure 300 can be integrated on a single substrate 301. The tunable waveguide 101 and a parallel waveguide 302 are both formed on the substrate 301, with a single input waveguide 303 and a single output waveguide 304.

FIG. 4 shows an embodiment 400 which uses a side polished single mode fiber 401, also known as a coupler-half or evanescent field access block. Here the fiber is mounted on a curved path, glued into a silica block 402, and polished so that a surface 403 within about 1 μm of the core is exposed. Thus, the evanescent field of the fiber 401 is accessible and can couple to a thin film 404 placed on the block surface.

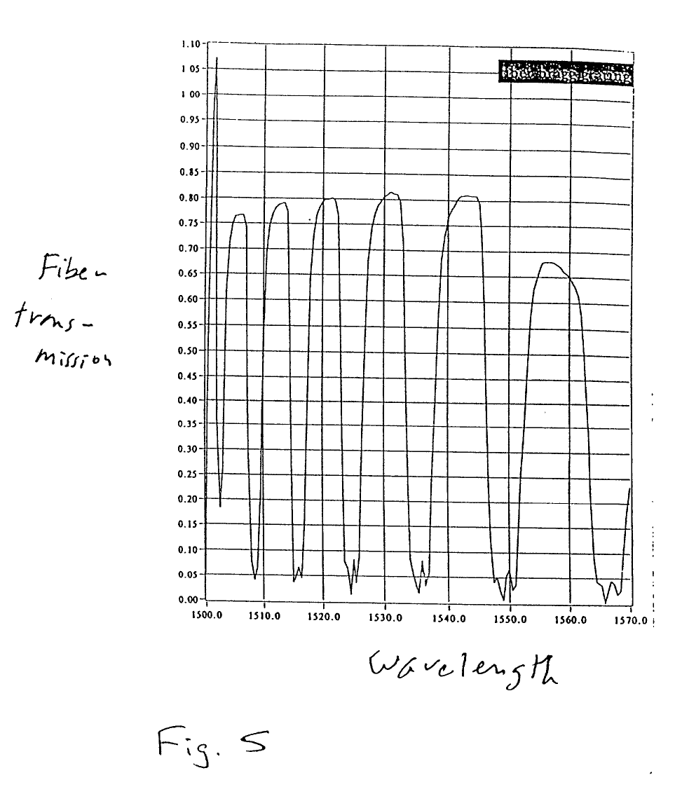

It is known that the transmission through such a fiber is strongly spectrally dependent. For example, FIG. 5 shows data on the fiber transmission of such a device, with an overlay oil film index n=1.65, over the band 1510-1570 nm. Note the strong periodicity of the fiber transmission, alternating with absorption into the modal resonances of the film. This periodicity would be even more dense for a film index n=3. If the film index is now altered by a small amount, for example dn/n≈0.005, then the spectral transmission of the coupler half will shift to the blue or red by approximately 0.005×1500 nm=7.5 nm. Thus 7.5 nm of tuning is caused in the fiber transmission.

Thus, optically induced index changes in the range of 3×10⁻⁴ to 5×10⁻³, or more can be used for practical devices.

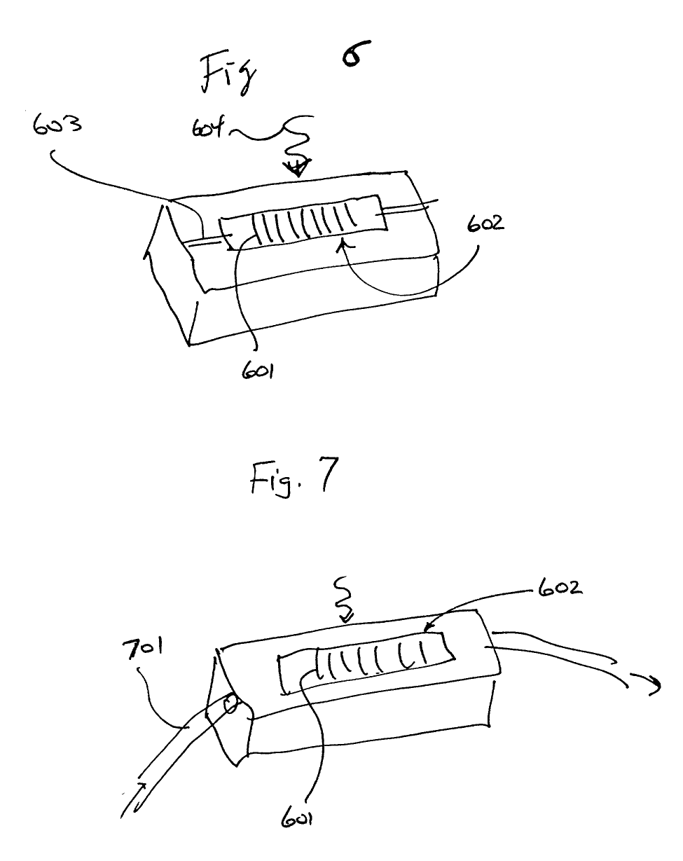

Another class of devices, shown in FIGS. 6 and 7, have gratings 601 impressed into the semiconductor waveguides 602 by lithography, forming a Bragg reflector with center wavelength for reflection=2 n D, where D is the period of said grating. This reflects light of this wavelength back into the waveguide 603. By optically tuning the value of n by external illumination 604, the reflective wavelength is varied. This is shown schematically in FIG. 6. Such a scheme could also be implemented in the side-polished fiber structure; in this case the grating 601 could act to drop a given wavelength=(n_{fiber}+N_{film})D from the fiber 701 by reflecting it backwards into the film 602, or a given wavelength=2 n_{fiber} D backwards into the fiber, as shown in FIG. 7.

In these embodiments, the structure of FIG. 6 is analogous to that of FIG. 1, while the structure of FIG. 7 is analogous to that of FIG. 4.

Related U.S. patent applications Ser. Nos. 09/813,365 and 09/813,454 describe methods for thin film deposition and for engineering the properties of such films.

The films used are amorphous or polycrystalline or microcrystalline semiconductors, or combinations of these, which may include Si or Ge or other species or alloys, in multiple layers, doped or intrinsic. These films, whose materials, composition and deposition and processing methods are described in the referenced related applications, have properties optimized for various applications and wavelengths. These layered film structures may comprise photoconductors, photodiodes, or phototransistors, in various embodiments, any of which shall be referenced as “optical sensors” for the purpose of this disclosure.

The films described in the noted related applications possess several useful properties, listed below.

Controlled absorption/transmission. Optical responses are provided at selected wavelength bands, with a controlled balance between partial absorption and partial transparency in order to respond to the light passing through the film while transmitting a portion, typically a larger portion, for example 80-90%, for use in the system. The bands of sensitivity and degree of transparency may be controlled over a broad range. For example, films of various different compositions may be responsive to selected bands within the 800-1600 nm range, which includes the principal datacom and telecom wavelengths.

Low temperature processing. The semiconductor films disclosed elsewhere are deposited by relatively low temperature processes, typically below 300° C. and in many cases, below 250° C., enabling deposition without damage onto fibers made of optical glass, fused silica, and in some cases onto polymer or plastic fibers.

Deposition onto nonplanar surfaces. The deposition processes are based primarily on plasma enhanced chemical vapor deposition (PECVD) methods supplemented by sputtering for certain layers and are suitable for producing spatially uniform coatings onto complex, nonplanar surfaces, such as the cylindrical surface near the end of an optical fiber. Methods of photolithography for the patterning of connecting traces and circuits will also be described for application to nonplanar surfaces.

The process of deposition of a photodiode, as a typical but not restrictive example of sensor fabrication, involves application of a transparent conducting layer, three or more semiconductor layers with various dopings, and a top transparent conducting layer. Passivation layers may also be required. In addition, photolithographic patterning is used to add metallic or other conductive electrodes in contact with key layers of the stack for bias and photocurrent access. In addition, for high optical transmission, there may be one or more anti-reflection layers deposited between the sensor films and the substrate before sensor deposition, and one or more anti-reflection layers after sensor deposition, between the sensor layers and air, as is known in the art. Thus, the total structure of films comprising the “smart surface” of the optical fiber may contain a substantial number of individual depositions and the use of different processes in sequence, possibly including thermal evaporation, electron beam evaporation, sputtering and PECVD, among others, and also photolithographic patterning steps to provide electrical contact to the front and back conducting films.

The present invention has now been described in connection with a number of specific embodiments of aspects thereof. However, numerous modifications, which are contemplated as falling within the scope of the present invention, some of which have been described above, should now be apparent to those skilled in the art. Therefore, it is intended that the scope of the present invention be limited only by the scope of the claims appended hereto.

What is claimed is:

1. A method of controlling an optical signal having a first wavelength, comprising:
passing the optical signal through a device, the device substantially transparent to the first wavelength; and
selectively illuminating the device with an optical signal at a second wavelength, illumination of the device by the second wavelength causing alteration of optical properties of the device relative to the first wavelength.

2. The method of claim 1, wherein the device is a Mach-Zender modulator.

3. The method of claim 1, wherein the device is a filter.

4. The method of claim 3, wherein the filter comprises:
a film having an index of refraction that varied in response to the second wavelength.

5. The method of claim 3, wherein the filter comprises:
a diffraction grating optically coupled to the side-polished fiber.

6. The method of claim 5, wherein the filter further comprises:
a side-polished fiber.

7. An optically controlled optical filter, comprising:
a semiconductor film whose transmission of a first optical wavelength varies with illumination at a second optical wavelength.

8. The filter of claim 7, wherein the semiconductor film has a refractive index at the first optical wavelength that varies with illumination as the second optical wavelength.

9. The filter of claim 7, further comprising:
a diffraction grating incorporated into the semiconductor film; and
a side-polished fiber coupled to the diffraction grating.
